(19) United States
(12) Patent Application Publication
(10) Pub. No.: US 2002/0189824 A1
(43) Pub. Date: Dec. 19, 2002

(54) System for fire extinguishing

(76) Inventor: Ezekiel Joseph, Bloomfield Township, MI (US)

Correspondence Address: Kohn & Associates, Suite 410, 30500 Northwestern Highway, Farmington Hills, MI, 48334, US

(21) Appl. No.: 10/140,421

(22) Filed: May 6, 2002

Related U.S. Application Data
(60) Provisional application No. 60/288,953, filed on May 4, 2001.

(51) Int. Cl. A62C 37/10

(52) U.S. Cl. 169/61; 340/584; 169/23

(57) ABSTRACT

There is provided an automated fire extinguishing system having a fire extinguisher for extinguishing a fire, the fire extinguisher including fire extinguishing media for extinguishing the fire, an alarm, a heat sensor for sensing heat, whereby when the heat reaches a preset temperature, the heat sensor activates the fire extinguishing system and the alarm, and at least one spray wand fluidly connected to said fire extinguisher, whereby the spray wand delivers the fire extinguishing media to an area in need of same.

### CROSS-RELATED REFERENCE SECTION

This application claims the benefit of priority under 35 U.S.C. Section 119(e) of U.S. Provisional Patent Application No. 60/288,953, filed May 4, 2001, which is incorporated herein by reference.

### BACKGROUND OF THE INVENTION

1. Technical Field

The present invention relates to a system for extinguishing fires. More specifically, the present invention relates to a system for extinguishing fires that includes a heat sensing device for sensing the fire.

2. Description of the Prior Art

The use of automatically activated fire extinguishing devices is well noted in the prior art. In the event of a cooking fire, such devices release a compound onto the stove surface, thereby extinguishing the fire. Typically, these automatic fire-extinguishing devices are contained in the range hood of the stove exposing unsightly and bulky cable, which accumulate grease over a period of time. Additionally, such devices have been found to be unreliable, falsely activating upon sensing heat without fire. Many of these devices also require on-site installation time, as well as complex automatic shut-off of electricity or gas to the stove requiring professional electrician installation, thereby adding to the stove's expense. Yet another disadvantage to the prior art devices includes an unsightly trigger mechanism that must be positioned for sensing heat from the stove.

An example of a prior art device is disclosed in U.S. Pat. No. 4,256,181 issued to Searcy. This device is a pressured fire-extinguishing vessel located in a remote station with lines to feed the range hood. This device houses a pyrotechnic sensor means that when ignited by flames, transfers the fire to a fusible link. Once the fusible link is severed, a valve on the fire extinguisher is opened, causing the fire extinguishing material to discharge in the location of the pyrotechnic sensor.

Another automatic fire extinguishing device is disclosed in U.S. Pat. No. 5,297,636 issued to North. This device also features a pressurized fire-extinguishing vessel. In this patent there is disclosed a residential fire extinguishing system comprising a delayed remote fire extinguisher mounted in a cabinet over the range, connected by flexible hoses to a pair of nozzles housed in the hood. In the event the fire extinguisher is activated to release the fire suppressant, the gas supply line is pressurized, thereby shutting off gas supply to the stove.

Yet another fire extinguishing device is disclosed in U.S. Pat. No. 5,899,278 issued to Mikulec. This device features a pressurized fire-extinguishing vessel. This patent provides for an automatically activated, self-contained remote station fire extinguishing stove device that is installed in a stove hood and features a compact design. In addition, this patent also provides for an automatic stove shut-off.

Mikulec discovered the need of alternating and changing the structure of the conventional fire extinguisher, by providing a device that is not pressurized. In U.S. Pat. No. 5,992,531, Mikulec discloses a non-pressured unit that can be utilized as a conventional fire extinguisher, or in an alternative embodiment, can be utilized above the stove. In order to accomplish this type of non-pressurized configuration, Mikulec designed the interior of the unit to include a spring-loaded plunger. This will provide for the plunger to be in a compressed state and allow for fluid to be stored therein. Once fire is detected, a fusible link melts and causes the spring to be released and innately provides for the fluid to be dispensed to the appropriate location. Though efficient, this device does not effectively utilize the spring, in that the spring reaches maximum velocity prior to fully dispensing the fluid. Thus, Mikulec relies mainly on gravity for dispensing the fire retardant material. A minimal amount of pressure is used and consequently, may not be adequate for dispensing the fire retardant media effectivity. In addition, Mikulec's fusible link system is complex in nature, and thus innately provides for a system that is not as economical if the design was more compact and included fewer components.

There would, therefore, be a need for an automatic fire extinguishing apparatus designed and configured to operate efficiently and one that will not require servicing during its shelf life, like conventional pressurized fire extinguishers. The device should be structured so as to provide a means of automatically extinguishing a cooking fire quickly and effectively by dispersing an extinguishing media over the source of fire. This device should be compact in size, adaptable to any room in the house, and optionally be adapted to be used in either a commercial or residential environment. Ideally, this apparatus also should be designed so as to allow for ease of installation and removal so as to innately provide for a non-pressurized fire extinguishing vessel that is self-contained within close proximity to a potential source of fire.

### SUMMARY OF THE INVENTION

According to the present invention, there is provided an automated fire extinguishing system having a fire extinguisher for extinguishing a fire, the fire extinguisher including fire extinguishing media for extinguishing the fire, an alarm, a heat sensor for sensing heat, whereby when the heat reaches a preset temperature, the heat sensor activates the fire extinguishing system and the alarm, and at least one spray wand fluidly connected to said fire extinguisher, whereby the spray wand delivers the fire extinguishing media to an area in need of same.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 is a schematic drawing of the wiring of the system of the present invention;

FIG. 2 is a drawing of the fire extinguishing system of the present invention;

FIG. 3 is a drawing of an alternative embodiment of the system of the present invention.

### DESCRIPTION OF THE INVENTION

Generally, the present invention provides a system, generally shown as 10, for automatically extinguishing fires. More specifically, the present invention provides a system 10 for extinguishing fires including a fire extinguisher 20, a heat sensor 12, an alarm 22, and a spray wand 24, all operatively connected. The system 10 works without human intervention and can, therefore, function properly even when individuals are not present. The system 10 is able to detect dangerous temperatures and upon such detection, activate the system 10, thereby preventing or stopping spread of a fire. The system 10 can be set up in single or multiple zones, depending upon the number of heat sensors 12 that are utilized.

“Dangerous temperatures” are defined as temperatures that are known to those of skill in the art to approach temperatures found in a fire.

The term “fire extinguisher” as used herein is intended to include any fire extinguisher 20 known to those of skill in the art. This can include, but is not limited to, commercially available fire extinguishers 20 and any other devices that are able to extinguish fires. In the preferred embodiment, the fire extinguisher 20 is approximately 18 inches tall and can fit easily within a box/cabinet 26, as can be seen in the attached figures. Alternatively, the fire extinguisher 20 can be a different fire extinguisher 20 that more specifically suits the situation in which the system 10 is placed. For example, if the system 10 is placed in a location for extinguishing a large fire, then a larger extinguisher should be utilized.

By “heat sensor” as used herein, the term is intended to include any sensor 12 that can detect a rise in temperature. The sensitivity of the heat sensor 12 is different depending upon the situation in which the system 10 is placed. For example, if the system 10 is to be placed in a car engine, the sensor 12 detects a change in the temperature only at higher temperatures, since an engine runs at a high temperature in a normal situation.

The “alarm” of the present invention is intended to include any device that can alert those within the vicinity of the system 10 of the presence of a fire. The alarm 22 alerts those in the near vicinity of a fire, so that the individuals can be alerted of a fire prior to the presence of a fire or prior to the individuals being in actual danger. The alarm 22 can be any alarm 22 known to one of skill in the art to function in this manner. For example this can include, but is not limited to, car alarms, alarms for use in smoke or carbon monoxide detectors, and other similar alarms.

The “spray wand” of the present invention is intended to include, but is not limited to, a piece of material that is able to disperse fire extinguishing material over the desired area. The spray wand 24 can be a piece of plastic or other similar material that contains holes drilled therein. The holes can be drilled in any configuration that functions best for extinguishing the fire. For example, when the system 10 is placed within a Christmas tree, then the wand has holes on all sides of the wand to ensure that the fire is extinguished.

The “solenoid” of the present invention connects or attaches to the fire extinguisher 20. Additionally, the solenoid 42 is electrically attached to the wire terminal 40 thereby creating circuitry between the solenoid 42, the heat sensor 12, the battery 14, and the alarm 22. When the heat sensor 12 senses temperatures in the dangerous range the circuit closes. The solenoid 42 is activated upon the closure of the circuit and this activates the fire extinguisher 20.

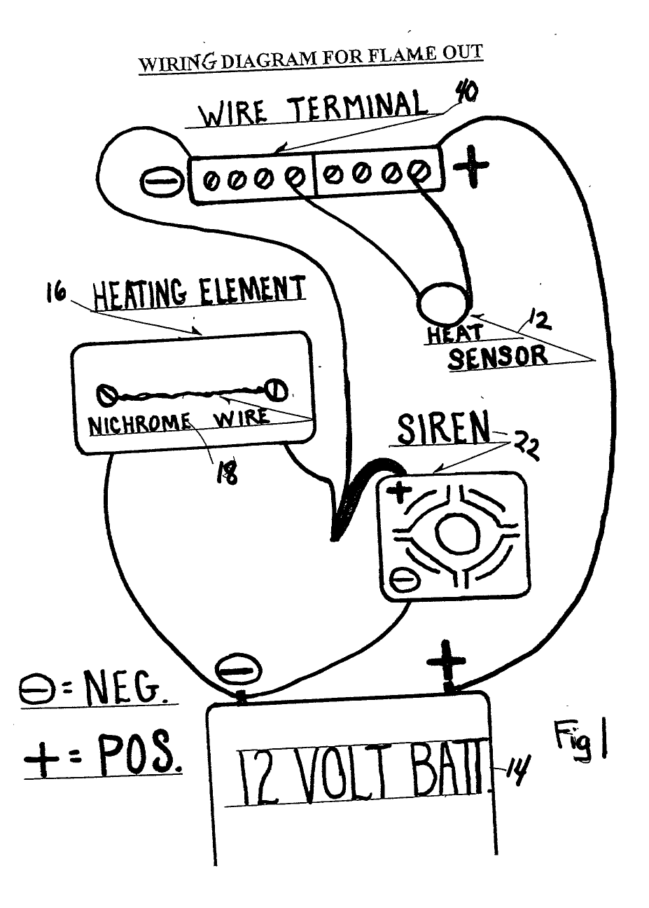

The fire extinguishing system 10 includes a fire extinguisher 20, a heat sensor 12, an alarm 22, and a spray wand 24 in electrical communication with one another. The connections are best shown in FIG. 1, wherein it is detailed the electrical connections that function to operate the fire extinguishing system 10 of the present invention. The entire system 10 is run by a power supply 14 connected to a wire terminal 40, which supports the circuitry for the entire system 10. The power supply 14 can include, but is not limited to, an electrical cord or any battery having sufficient power to operate the fire extinguishing system 10. In the preferred embodiment, a 12-volt battery is the power supply used.

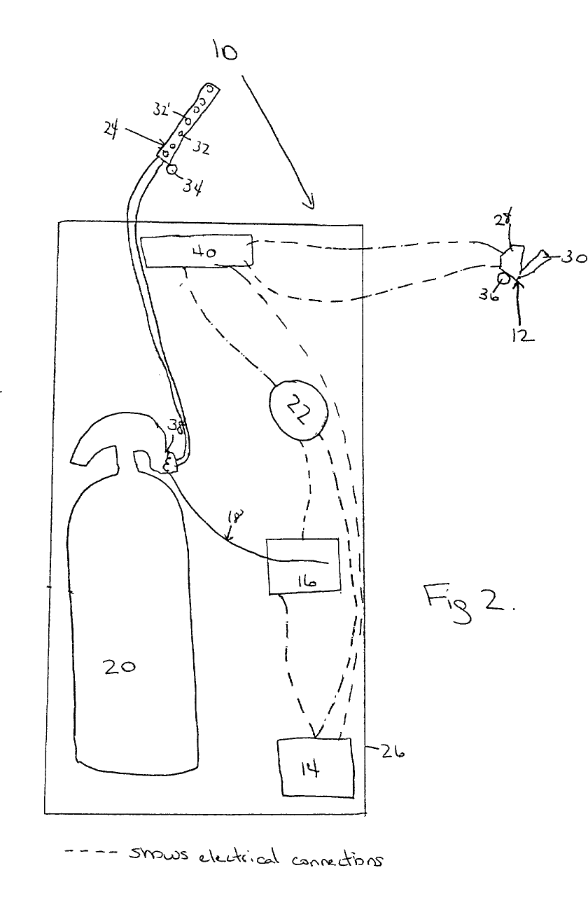

As shown in FIG. 2, the fire extinguishing system 10 contains a fire extinguisher 20. The fire extinguisher 20 is attached to a spring 38 or similar device using nylon or other meltable string 18. The string 18 connects the fire extinguisher 20 to the spring 38 and keeps the fire extinguisher 20 from activating. The string 18 is placed over a heating device 16. When the circuit is closed, which happens when the sensor 12 senses dangerous temperatures, the heating element 16 is activated as well as the alarm 22. The heating element 16 then heats up and melts the string 18. This then enables the fire extinguisher 20 to be activated.

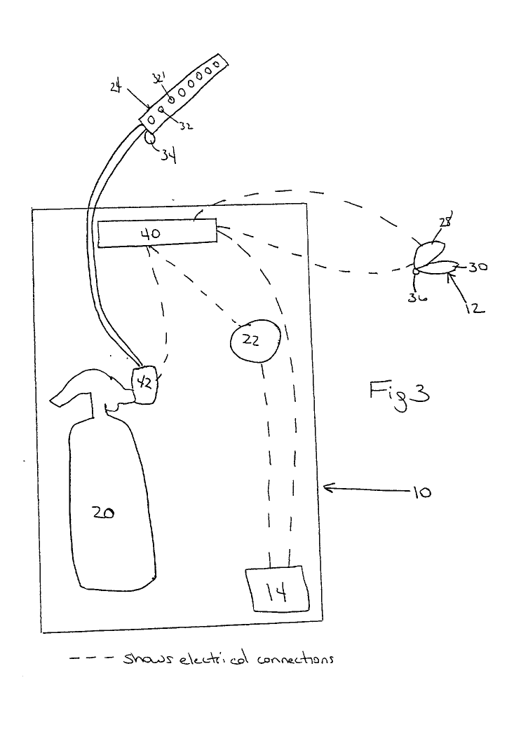

Alternatively, the fire extinguishing system 10, as shown in FIG. 3, can contain a fire extinguisher 20 that has attached thereto a solenoid 42 or similar device. The solenoid 42 is attached at the top of the fire extinguisher 20 and eliminates the need for the heating device 16, spring 38, and string 18 disclosed above. Instead, the solenoid 42, which is commonly found in water sprinkler systems, functions when it receives an electrical signal from the heat sensor 12 via the wire terminal 40. The signal closes the electrical circuit of the system 10 and thereby activates the parts of the system 10. When the circuit is closed, which happens when the sensor 12 senses dangerous temperatures, the heating element 16 is activated as well as the alarm 22. The solenoid 42 is then activated, whereby the solenoid 42 opens, and thereby enables fire extinguishing media to be released from the fire extinguisher 20, thus activating fire extinguisher 20. More specifically, the system 10 is armed when a handle on the fire extinguisher 20 is opened and the contents of the fire extinguisher 20 are released.

The activation of the fire extinguisher 20 forces fire extinguishing material to be sprayed out through the spray wand 24 via the holes in the spray wand 32, 32′.

The heat sensor 12, as used in the present invention, functions because the heat sensor 12 includes two metal parts 28, 30 that come into closer proximity with one another as the temperature approaches the dangerous temperatures. This closure completes the circuit of the system 10 and activates the system 10. Alternatively, the heat sensor 12 can function via remote control. For example, when the heat sensor 12 senses a rise in temperature to a dangerous level, the sensor 12 provides a radio signal to activate the system 10. The signal also can be any other type of signal that works remotely and is known to those of skill in the art.

The spray wand 24 is operatively connected to the fire extinguisher 20 such that when the fire extinguisher 20 is activated, the active ingredient in the fire extinguisher 20 is forced into the spray wand 24. The pressure that subsequently builds up within the spray wand 24 forces the active ingredient out of the holes 32, 32′ drilled within the spray wand 24.

The spray wand 24 and heat sensors 12 of the present invention are held in place using affixing devices 34, 36. The affixing devices 34, 36 can include, but are not limited to, screws, suction cups, Velcro, magnets, glue, and other similar affixing devices. The spray wand 24 is affixed in place directly adjacent to the location of the potential fire. The heat sensor 12 is affixed in a location sufficient for sensing the temperature of the area in need of protection.

In the preferred embodiment, the system 10 of the present invention is placed in a box/container 26 adjacent the desired location. This container 26 can be a box, a cabinet, a decorated container, or other similar device known to those of skill in the art. The container 26 can be made of metal, wood, plastic and other materials known to those of skill in the art. The container 26 is utilized specifically to contain the fire extinguishing system 10 in a more attractive container. The container 26 is made such that it can be installed in an appropriate location for extinguishing fires.

The automatic fire extinguishing system 10 is designed and configured to be removably secured to any cabinet 26 location so as to offer protection by having a means of automatically extinguishing a fire safely, quickly and efficiently. The structure and design of the fire extinguishing system 10 are such that it is installed easily and is non-obtrusive and provides for an aesthetically pleasing container 26 while offering protection to the consumer. Since the system 10 is structured so as to be located in a non-obtrusive location, it is not visible or only partially visible when installed. The location of the system 10 is such that it operates quickly and efficiently when a fire is present, thus providing for a device that offers adequate fire prevention. For example, the system 10 can be installed in cabinetry adjacent a stove, such that the system 10 appears identical to the existing cabinetry.

Alternatively, conventional means, such as the use of brackets, magnets, or the like, can be utilized for securing the unit to the existing cabinetry 26. Optionally, a casing can be secured to the lower surface of the cabinet 26 and this casing can removably receive the housing as describe above. This enables the casing to act as a holding sleeve for maintaining and securing the housing to the cabinet 26.

Once the device has been used (a fire has been extinguished), the extinguisher 20 is replaced, or if damage has not occurred with the unit, then the dispersing media can be replaced. Replacement can be accomplished by way of a cylinder (new housing) or by filling the existing fire extinguisher 20 with the desired material.

The system 10 of the present invention can be used to extinguish fires in a range of situations. For example, the system 10 can be used in the following situations: in a car engine, in a kitchen, around a Christmas tree, around a fireplace, in a bedroom, and in any other situation in which fire prevention is necessary as is known to those of skill in the art. When the system 10 is placed within a room for extinguishing fires, the system 10 can include multiple wands and can rotate such that when the system 10 is activated, the entire system 10 rotates and functions to spray an active ingredient found in a fire extinguisher 20 and is sprayed in a fashion similar to a lawn sprinkler.

Throughout this application, various publications, including United States patents, are referenced by author and year, and patents, by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. An automated fire extinguishing system comprising:
fire extinguishing means for extinguishing a fire, said fire extinguishing means including fire extinguishing media and a spray wand for dispensing said fire extinguishing media;
an alarm;
heat sensor means for sensing heat, whereby when the heat reaches a preset temperature, said heat sensor means activates said fire extinguishing system and said alarm; and
at least one spray wand fluidly connected to said fire extinguishing means, whereby said spray wand delivers the fire extinguishing media to an area in need of same.

2. The fire extinguishing system according to claim 1, wherein said heat sensor means includes at least two parts, whereby the connection of the two parts activate the fire extinguishing system.

3. The fire extinguishing system according to claim 1, wherein said alarm is selected from the group consisting essentially of car alarms, alarms for use in smoke, and alarms for use in carbon monoxide detectors.

4. The fire extinguishing system according to claim 1 further including power means for powering said fire extinguishing system.

5. The fire extinguishing system according to claim 4, wherein said power means is selected from the group consisting essentially of a power cord and a battery.

6. The fire extinguishing system according to claim 1, wherein said spray wand includes apertures therein for releasing the fire extinguishing media.

7. The fire extinguishing system according to claim 1 further includes affixing means for affixing said heat sensor means in place.

8. The fire extinguishing system according to claim 7, wherein said affixing means are selected from the group consisting essentially of screws, suction cups, Velcro, magnets, and glue.

9. The fire extinguishing system according to claim 1 further includes affixing means for affixing said spray wand in place.

10. The fire extinguishing system according to claim 9, wherein said affixing means are selected from the group consisting essentially of screws, suction cups, Velcro, magnets, and glue.

11. A fire extinguishing system automatically actuated in response to flames from a fire, said fire extinguishing system comprising:
a pressurized fire extinguisher having a string actuated spring biased to the closed position, said extinguisher including a supply of fire extinguishing material;
a spray wand coupled to the spring of said fire extinguisher and being positioned above the location of the fire for distributing the fire extinguishing material from the extinguisher over the upper surface of the fire location when said spring is in the open position, said spring maintaining said valve in the closed position;
means coupled to said spring for biasing said valve to the open position;
a heat sensor means coupled to said spring and being positioned above the potential fire location for sensing dangerous temperatures and transferring such senses to said spring; and
a heating element coupled to said spring for severing a string maintaining the spring in closed position, whereby when the heating element heats said string is severed and said spring opens and said extinguisher discharges the fire extinguishing material through said spray wand onto the fire location.

12. The fire extinguishing system according to claim 11, wherein said heat sensor means includes at least two parts, whereby the connection of the two parts activate the fire extinguishing system.

13. The fire extinguishing system according to claim 11, wherein said alarm is selected from the group consisting essentially of car alarms, alarms for use in smoke, and alarms for use in carbon monoxide detectors.

14. The fire extinguishing system according to claim 11 further including power means for powering said fire extinguishing system.

15. The fire extinguishing system according to claim 14, wherein said power means is selected from the group consisting essentially of a power cord and a battery.

16. The fire extinguishing system according to claim 11, wherein said spray wand includes apertures therein for releasing the fire extinguishing media.

17. A fire extinguishing system automatically actuated in response to flames from a fire, said fire extinguishing system comprising:
a pressurized fire extinguisher, said extinguisher including a supply of fire extinguishing material;
a spray wand coupled to the spring of said fire extinguisher and being positioned above the location of the fire for distributing the fire extinguishing material from the extinguisher over the upper surface of the fire location;
solenoid means coupled to said spring for biasing said valve to the open position;
a heat sensor means coupled to said spring and being positioned above the potential fire location for sensing dangerous temperatures and transferring such senses to said spring, whereby said solenoid means is connected to said heat sensor means and activation of said heat sensor means activates said solenoid means.

18. The fire extinguishing system according to claim 17, wherein said affixing means are selected from the group consisting essentially of screws, suction cups, Velcro, magnets, and glue.

19. The fire extinguishing system according to claim 11 further includes affixing means for affixing said spray wand in place.

20. The fire extinguishing system according to claim 19, wherein said affixing means are selected from the group consisting essentially of screws, suction cups, Velcro, magnets, and glue.
